(19) United States
(12) Patent Application Publication
(10) Pub. No.: US 2009/0273106 A1
(43) Pub. Date: Nov. 5, 2009

(54) Porous Carbon Membranes and Their Forming Method

(75) Inventors: Sheng-Diann Lin, Taoyuan (TW); Li-Chun Chen, Taoyuan (TW)

Correspondence Address: WPAT, PC, 7225 BEVERLY ST., ANNANDALE, VA, 22003, US

(73) Assignee: YUAN ZE UNIVERSITY, Taoyuan (TW)

(21) Appl. No.: 12/114,086

(22) Filed: May 2, 2008

(51) Int. Cl. B28B 1/14

(52) U.S. Cl. 264/29.5; 264/308

(57) ABSTRACT

The present invention discloses a method for fabricating a carbon membrane having pore regularity. The method comprises: providing a template having a plurality of pores arranged regularly; performing a tubular carbon forming process in the regularly-arranged pores; then performing a removal process to form an annular cavity; performing a carbon forming process in the annular cavity to combine the carbon in the annular cavity with the tubular carbon to thereby form a carbon substance having a thick wall; and repeatedly performing the removal process and the carbon forming process so as to form a carbon membrane having pore regularity.

### BACKGROUND OF THE INVENTION

1. Field of the Invention

The present invention is generally related to a porous carbon membrane, and more particularly to a method for fabricating a carbon membrane having pore regularity and its applications in filtration material, electrode material, hydrogen storage, fuel cell electrodes and/or membrane electrode assembly of a fuel cell.

2. Description of the Prior Art

At present, in the electrode of a fuel cell, the transport interface of electron and gas to or from catalyst layer is built by a gas diffusion layer (GDL). Usually carbon paper or carbon cloth is a main substrate. In the traditional electrode preparation, the GDL should be treated by Teflon to become hydrophobic to avoid the electrode flooding phenomenon. However, beside the above matter, the discussion about other properties in the GDL treatment has not been reported. Using an external electric field to fabricate an electrode with structural regularity has been reported. The patent by 3M Co. discloses using regularly-arranged carbon structure as the substrate for electrode catalyst that is claimed to have higher electrode efficiency. The current suppliers of using carbon paper/carbon cloth as the GDL have various pretreatment processes in fabrication. The common one is to coat carbon paper/carbon cloth with carbon black particles. Generally, this coating layer is considered to make the surface of the GDL smoother so as to promote the electrode efficiency. The result shows that the structure of the carbon GDL affects the electrode efficiency but the real reason of effectively promoting the electrode efficiency is not reported.

For GDL role playing in an electrode structure, GDL has to be a good electron transport material so as to effectively collect and transport the electrons in the electrode reactions. According to reports in the past, the properties of the microstructures for porous electrode materials, comprising the type, size, distribution, regularity of pores, are closely related to the electrical properties thereof. The porous structure of carbon paper/carbon cloth provides incoming and outgoing channels for the reaction gas and has to be treated to become hydrophobic, in order that the porous structure will not be completely filled with water and that gas transport will not be blocked due to capillarity. Both electrical conductivity and hydrophobicity are required for a GDL carbon material. Theoretically, gas transport in a porous structure is affected by the dimension of the pore channel. The longer is the pore channel, the slower is gas transport. Thus, the pore channel in the porous structure is a factor in gas transport as well as the efficiency of electrode reaction. Therefore, in view of the above mentioned problems, a novel method for fabricating a carbon membrane having pore regularity applicable to fuel cells is needed to fulfill the requirements of high conductivity and surface hydrophobic property. It is also an important research topic in industry.

### SUMMARY OF THE INVENTION

In light of the above mentioned background, in order to fulfill the requirements of the industry, the present invention provides a method for fabricating a carbon membrane having pore regularity and its applications.

One object of the present invention is to use a template comprising a plurality of pores arranged regularly to fabricate a carbon membrane having pore regularity. The carbon membrane can be utilized in filtration material and can be applied in filtration under the severe conditions, such as strong acid, strong base, and high temperature. It is also applicable as the gas transport layer in a fuel cell. The carbon membrane can also be extended to be a support for metal or other nanoparticles so that the carbon membrane has functions of transporting gas and supported catalyst and can be used as a substrate to be filled with other functional material in the applications for hydrogen storage and electrode materials. Furthermore, membrane separation technology is a new efficient separation technology with the advantages of high efficient. After modifying surface morphology of the carbon membrane or other post-treatment, the carbon membrane can be applied to biological products extraction, separation and purification.

Another object of the present invention is to control the pore dimension of a carbon membrane in a simple manner during fabrication. The gas transport channel formed in the invention is a straight tubular structure to accelerate gas transport. In addition, in order to prevent the electrode flooding phenomenon during applying the carbon membrane, the channel surface in the carbon structure can be processed by graphitizing or surface hydrophobic treatment. Therefore, this present invention does have the economic advantages for industrial applications.

Accordingly, the present invention discloses a method for fabricating a carbon membrane having pore regularity. The method comprises: providing a template having a plurality of pores arranged regularly; performing a tubular carbon forming process in the regularly-arranged pores; then performing a removal process to form an annular cavity; performing a carbon forming process in the annular cavity to combine the carbon in the annular cavity with the tubular carbon to thereby form a carbon substance having a thick wall; and repeatedly performing the removal process and the carbon forming process so as to form a carbon membrane having pore regularity.

### BRIEF DESCRIPTION OF THE DRAWINGS

FIG. 1 shows a scanning electron microscopic picture of an anodic aluminum oxide template;

FIG. 2 shows a scanning electron microscopic picture of a carbon membrane having pore regularity fabricated by the method according to one preferred embodiment of the present invention; and

FIG. 3 shows a scanning electron microscopic picture of a carbon array structure fabricated by the method according to the prior art.

### DESCRIPTION OF THE PREFERRED EMBODIMENTS

What is probed into the invention is a method for fabricating a carbon membrane having pore regularity and its applications. Detail descriptions of the steps and compositions will be provided in the following in order to make the invention thoroughly understood. Obviously, the application of the invention is not confined to specific details familiar to those who are skilled in the art. On the other hand, the common steps and compositions that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

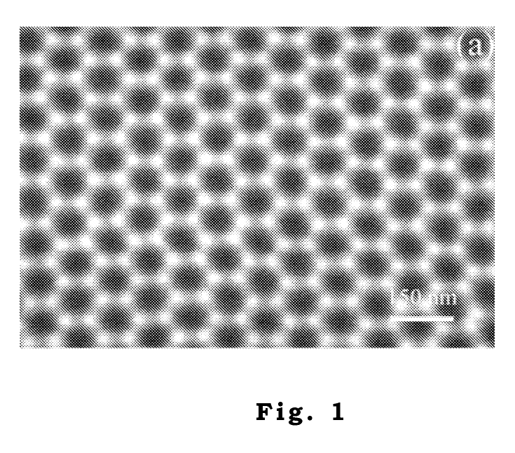

The common reported template method usually uses nano-porous membranes composing of macromolecules (polycarbonate, polyester, etc.) or oxides having pore regularity. The common commercial macromolecule template has a thickness about 6-10 μm and lower pore density about 10⁶-10⁸/cm². The oxide templates having pore regularity comprise zeolite and anodic aluminum oxide (AAO) membranes. There are various types of oxide templates, such as having different structures like micropore, mesopore, straight pore or branched pore. Thus, one advantage is that the carbons having different pore structures can be formed from these various templates. However, the membrane made from zeolite can not have long-range pore regularity and thus the carbon membrane having a structure with long-range pore regularity can not be made. On the contrary, AAO membranes are matured commercial products such as Whatman Anodisc®. The pores of an AAO template show hexagonal close packed arrangement, shown in FIG. 1, and the AAO template has higher pore density about 10⁹-10¹²/cm². The membrane with a diameter as large as 47 mm and a thickness of 60 μm can be purchased with selection of pore size from tens to hundreds nanometer, and is a suitable template substrate for fabricating a carbon membrane.

One embodiment of the invention discloses a method for fabricating a carbon membrane having pore regularity. At first, a template having a plurality of pores arranged regularly is provided. The template is selected from the group consisting of organic and inorganic nanoporous substrates such as anodic aluminum oxide, macromolecule template, and zeolite. Then, a tubular carbon forming process in the regularly-arranged pores is performed. Besides, the contact surface between the pore wall of the regularly-arranged pore and the tubular carbon is defined as a connecting surface. A removal process to remove a part of the template from the connecting surface toward outside is performed to form an annular cavity.

Following that, a carbon forming process in the annular cavity is performed to fill the annular cavity with carbon. The carbon in the annular cavity is combined with the tubular carbon to thereby form a carbon substance having a thick wall. By repeatedly performing the removal process and the carbon forming process, the whole template is removed and the carbon is formed to completely fill the inter-cavities of the carbon substances having a thick wall. Thus, a carbon membrane having pore regularity is formed.

The above mentioned tubular carbon forming process comprises a first infiltrating process and a first carbonizing process. The first infiltrating process is to infiltrate a carbon precursor to the wall surfaces of the regularly-arranged pores. In addition, the first carbonizing process to carbonize the carbon precursor on the wall surfaces so as to form the tubular carbon.

In this embodiment, the following shows three preferred examples for the above mentioned tubular carbon forming process.

In a first preferred example of the tubular carbon forming process, the first infiltrating process is a coating process. The carbon precursor is a carbon source molecule. The coating process is to evenly coat the carbon source molecules with appropriate viscosity on the wall surfaces of the regularly-arranged pores. The carbon source molecule is selected from the group consisting of the following: macromolecule solution, saccharide solution, and other liquid form carbon sources.

In a second preferred example of the tubular carbon forming process, the first infiltrating process is a deposition process that is selected from the group consisting of the following: liquid deposition method and gas deposition method. The preferred one is a sol-gel method, electroless plating, electrodeposition, chemical vapor deposition method, or physical vapor deposition method.

In a third preferred example of the tubular carbon forming process, a polymerization process to polymerize the carbon precursor on the wall surfaces is included after the first infiltrating process and before the first carbonizing process.

Furthermore, the removal process removes the template by using a corrosive solution to wash from the connecting surface toward outside. The corrosive solution is selected from the group consisting of the following: strong acidic solution and strong basic solution.

The above mentioned carbon forming process comprises a second infiltrating process and a second carbonizing process. The second infiltrating process is to infiltrate a carbon precursor to fill the annular cavity. The second carbonizing process is to carbonize the carbon precursor in the annular cavity and to combine the carbon in the annular cavity with the tubular carbon to thereby form a carbon substance having a thick wall.

In this embodiment, the following shows three preferred examples for the above mentioned carbon forming process.

In a first preferred example of the carbon forming process, the second infiltrating process is a filling process, the carbon precursor is a carbon source molecule, and the filling process is to fill the annular cavity with the carbon source molecules having appropriate viscosity. The carbon source molecule is selected from the group consisting of the following: macromolecule solution, saccharide solution, and other liquid-form carbon sources.

In a second preferred example of the carbon forming process, the first infiltrating process is a deposition process that is selected from the group consisting of the following: liquid deposition method and gas deposition method. The preferred one is a sol-gel method, electroless plating, electrodeposition, chemical vapor deposition method, or physical vapor deposition method.

In a third preferred example of the carbon forming process, a polymerization process to polymerize the carbon precursor in the annular cavity is included after the second infiltrating process and before the second carbonizing process.

On the other hand, the first and second carbonizing processes are both pyrolysis processes having the temperature more than or equal to 500° C. In the above embodiment, the preferred carbon membrane comprises aligned carbon nanotubes (CNT), carbon nanofibers (CNF), etc. Generally, the chemical vapor deposition method is a common method to fabricate CNT. Transition metal catalyst is plated on the substrate by ion plating or thermal evaporation, or liquid coating method. It is then annealed or reduced to become metal nanoparticles. Then, hydrocarbon compounds like acetylene and methane are undergoing chemical vapor deposition to form carbon nanotubes. The advantages of this process are low process temperature, uniform distribution, high purity, low cost, simple process, large area, and regularly-arranged carbon nanotubes.

The chemical vapor deposition (CVD) method comprises (1) thermal CVD and (2) microwave plasma CVD (MPCVD). The thermal CVD vaporizes and decomposes catalyst into small grains in a high temperature furnace; then removes oxides on the surface of transition metal; and finally introduces hydrocarbon compounds as carbon source gas to synthesize CNT. This method does not need a substrate coated with transition metal catalyst. Therefore, CNT can be continuously synthesized. In a high temperature furnace, argon gas is introduced and heated to 1000° C. Then, hydrogen gas is introduced to reduce metal oxide. After 1-hour deposition, hydrogen gas is introduced and the furnace is cooled to room temperature. CNT can then be obtained. On the other hand, MPCVD is a newly developed method to control the growing direction of CNT and reduce the growing time as well. This method is to have metal catalyst plated on a chip and then to place in a MPCVD apparatus for growing CNT. The gas mixture of methane and hydrogen or the gas mixture of acetylene and ammonia is used. The method uses catalyst to dissociate hydrocarbon compounds. Since the reaction is taken place in plasma, highly reactive gas like N₂ and H₂ can activate metal catalyst and thus the CNT fabrication can be carried out at lower temperature.

The carbon membrane having pore regularity fabricated by the method according to the invention is applied in fabricating fuel cell electrodes and/or the membrane electrode assembly of a fuel cell, particularly in fabricating a gas diffusion layers and/or a catalyst supporting layer. Generally, as the hydrophobicity of a surface is high, the pore with micron and submicron size does not have the water flooding phenomenon. In addition, a pore channel with micron and submicron size has good gas permeability. If the hydrophobicity of a pore surface is low, the pore channel will have the water flooding phenomenon due to capillarity. The smaller is the pore channel, the worse is the water flooding phenomenon. Thus, the carbon membrane needs to have its surface be hydrophobic in order to be applied in the gas diffusion layer of a fuel cell. It can be accomplished by graphitizing the structure. The graphitized structure also has higher electrical conductivity. In the above embodiment, after the carbon membrane having pore regularity is formed, a high temperature treatment process to graphitize the carbon membrane can be carried out. Besides graphitization, surface treatment is also a method to alter surface property to become hydrophobic. After the carbon membrane having pore regularity is formed, a hydrophobic surface modification process can be performed. In addition, it can also be treated by a hydrophilic surface modification after the carbon membrane having pore regularity is formed. Therefore, the treated carbon membrane has affinity to some hydrophilic substance, such as biomolecules.

As described in the above, the preferred carbon membrane material is CNT. The CNT has very special electrical and physical properties. The electrical property of carbon nanotubes (CNT) changes with the crystal structure of the carbon nanotubes. Different diameters and helicity will result in different electrical property for CNT, such as being semiconductor or metal.

### EXAMPLE 1

### Processes For Fabricating a Carbon Membrane Having Pore Regularity

Step 1: An anodic aluminum oxide (AAO) template having a plurality of pores arranged regularly is dipped in an epoxy solution and thereafter a carbonization process at 923K under nitrogen environment is performed;

Step 2: a strong basic solution (potassium hydroxide solution) is used to remove a part of the AAO template; and

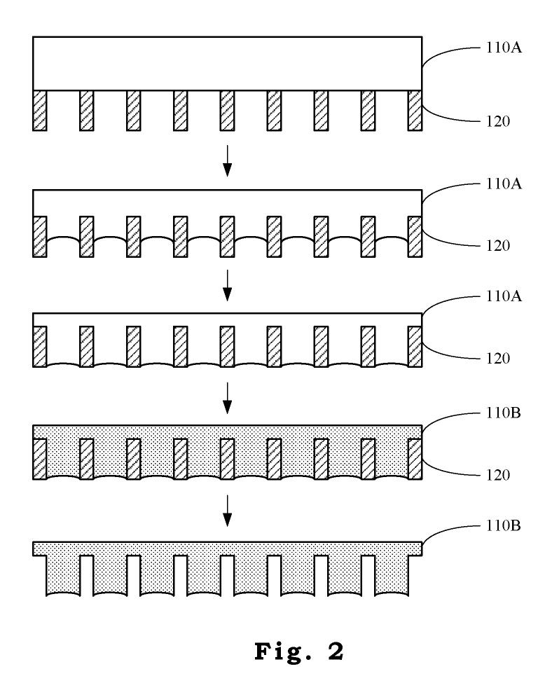

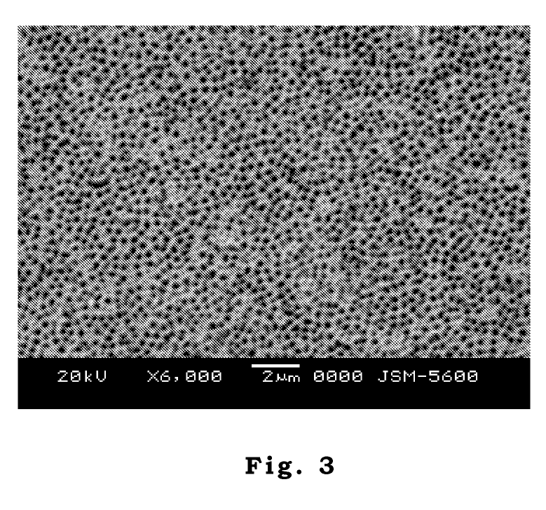

Step 3: step 1 and step 2 are performed repeatedly until the whole AAO template is removed so as to form a carbon membrane having pore regularity, as shown in FIG. 2.

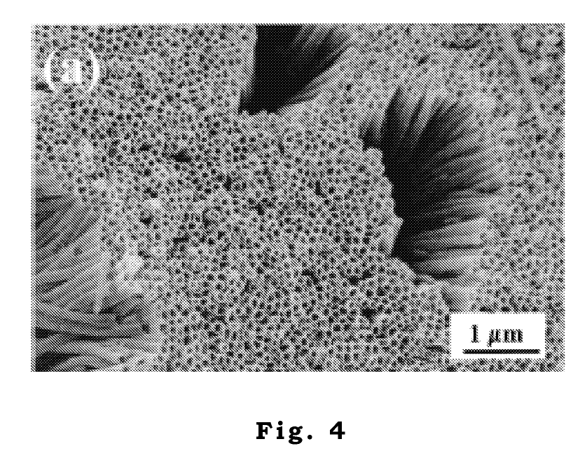

As shown in FIG. 3, the early report, from C.-T. Hsieh, J.-M. Chen, R.-R. Kuo, Y.-H. Huang, Appl. Phys. Lett. 84(2004)1186, uses the AAO template and one-step removing method to fabricate a carbon structure that is a carbon membrane structure with structural defect. In comparison, this invention uses a multi-step removing method to fabricate a carbon structure that is a whole continuous carbon membrane structure. Thus, the invention solves the existing structural defect problem of a membrane in the prior art. This invention can not be accomplished easily.

As described in the above, the carbon membrane having pore regularity fabricated by the method according to the invention is applied in fabricating a gas diffusion layer and/or a catalyst supporting layer. Therefore, after the carbon membrane having pore regularity is formed, a catalyst particle deposition process is performed to have the carbon membrane be able as a catalyst supporting body. After the carbon membrane having pore regularity is formed, the carbon membrane, processed by graphitizing and hydrophobic surface modification processes, has the function of the gas diffusion layer. Moreover, after the catalyst particle deposition process, the carbon membrane becomes a composite carbon membrane having both of the gas diffusion and catalyst support functions.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A method for fabricating a carbon membrane having pore regularity, comprising:
providing a template having a plurality of pores arranged regularly;
performing a tubular carbon forming process in said regularly-arranged pores and defining the contact surface between the pore wall of said
regularly-arranged pore and said tubular carbon as a connecting surface;
performing a removal process to remove a part of said template from said connecting surface toward outside so as to form an annular cavity;
performing a carbon forming process in said annular cavity to fill said annular cavity with carbon and to combine the carbon in said annular cavity with said tubular carbon to thereby form a carbon substance having a thick wall; and
repeatedly performing said removal process and said carbon forming process to remove the whole template and to form carbon filling in the inter-cavities of said carbon substances having a thick wall so as to form a carbon membrane having pore regularity.

2. The method according to claim 1, wherein said template is selected from the group consisting of the following: anodic aluminum oxide, macromolecule template, and zeolite.

3. The method according to claim 1, wherein said tubular carbon forming process comprises:
performing a first infiltrating process to infiltrate a carbon precursor to the wall surfaces of said regularly-arranged pores; and
performing a first carbonizing process to carbonize said carbon precursor on the wall surfaces so as to form said tubular carbon.

4. The method according to claim 3, further comprising a polymerization process to polymerize said carbon precursor on the wall surfaces after said first infiltrating process and before said first carbonizing process.

5. The method according to claim 3, said first infiltrating process is a coating process, said carbon precursor is a carbon source molecule, and said coating process is to coat said carbon source molecules with appropriate viscosity on the wall surfaces of said regularly-arranged pores.

6. The method according to claim 5, wherein said carbon source molecule is selected from the group consisting of the following: macromolecule solution, saccharide molecule solution, and carbon source gas.

7. The method according to claim 3, wherein said first infiltrating process is a deposition process that is selected from the group consisting of the following: liquid deposition method and gas deposition method.

8. The method according to claim 3, wherein said deposition process is selected from the group consisting of the following: sol-gel method, electroless plating, electrodeposition, chemical vapor deposition method, and physical vapor deposition method.

9. The method according to claim 3, wherein said first carbonizing process is a pyrolysis process and the temperature of said pyrolysis is more than or equal to 500° C.

10. The method according to claim 1, wherein said removal process removes said template by using a corrosive solution to wash from said connecting surface toward outside.

11. The method according to claim 10, wherein said corrosive solution is selected from the group consisting of the following: strong acidic solution and strong basic solution.

12. The method according to claim 1, wherein said carbon forming process comprises:
performing a second infiltrating process to infiltrate a carbon precursor to fill said annular cavity; and
performing a second carbonizing process to carbonize said carbon precursor in said annular cavity and to combine the carbon in said annular cavity with said tubular carbon to thereby form a carbon substance having a thick wall.

13. The method according to claim 12, further comprising a polymerization process to polymerize said carbon precursor in said annular cavity after said second infiltrating process and before said second carbonizing process.

14. The method according to claim 12, said second infiltrating process is a filling process, said carbon precursor is a carbon source molecule, and said filling process is to fill said annular cavity with said carbon source molecules with appropriate viscosity.

15. The method according to claim 14, wherein said carbon source molecule is selected from the group consisting of the following: macromolecule solution, saccharide molecule solution, and carbon source gas.

16. The method according to claim 12, wherein said second infiltrating process is a deposition process that is selected from the group consisting of the following: liquid deposition method and gas deposition method.

17. The method according to claim 16, wherein said deposition process is selected from the group consisting of the following: sol-gel method, electroless plating, electrodeposition, chemical vapor deposition method, and physical vapor deposition method.

18. The method according to claim 12, wherein said second carbonizing process is a pyrolysis process and the temperature of said pyrolysis is more than or equal to 500° C.

19. The method according to claim 1, after forming said carbon membrane having pore regularity, further comprising: a high temperature treatment process to graphitize said carbon membrane.

20. The method according to claim 1, after forming said carbon membrane having pore regularity, further comprising: a hydrophilic surface modification process.

21. The method according to claim 1, after forming said carbon membrane having pore regularity, further comprising: a hydrophobic surface modification process.

22. The method according to claim 1, after forming said carbon membrane having pore regularity, further comprising: a catalyst particle deposition process.

23. The method according to claim 1, wherein said carbon membrane having pore regularity is applied in preparing the electrode of a fuel cell and/or the membrane electrode assembly of a fuel cell.

24. The method according to claim 1, wherein said carbon membrane having pore regularity is applied in preparing a gas diffusion layer and/or catalyst supporting layer.
